(19) United States
(12) Patent Application Publication
(10) Pub. No.: US 2020/0070070 A1
(43) Pub. Date: Mar. 5, 2020

(54) FILTERING DEVICE

(71) Applicant: TAIWAN GRACE INTERNATIONAL CORP., Taipei City (TW)

(72) Inventor: Ming-Chih Pan, Taipei City (TW)

(21) Appl. No.: 16/121,641

(22) Filed: Sep. 5, 2018

(51) Int. Cl. B01D 29/27

(52) U.S. Cl. CPC B01D 29/27; B01D 2201/34

(57) ABSTRACT

A filtering device includes a filter unit including a first annular body and a filter bag in combination therewith, the top face of the first annular body is folded outward to form an outer eaves portion, the outer side bottom of which is configured with a second annular body, the filter unit is in combination with a housing, the inner wall of the top of which is configured downward with an annular second stepped portion, the inside of the housing has an accommodation space in communication with the outside, the top face of the housing is in combination with a cover used to seal the accommodation space, the diameter of the second annular body is larger than the one of the second stepped portion, allowing the second annular body to be pressed to engage with the second stepped portion and to expand to pressed against the second stepped portion.

### (a) TECHNICAL FIELD OF THE INVENTION

The present invention relates to a filtering device, and more particularly to a filter bag in a filter bag type filtering device.

### (b) DESCRIPTION OF THE PRIOR ART

Conventional industrial filtering equipment can make the top end face and bottom end face of a filter core all be sealed, and the bottom end and the outer wall around the bottom end all be covered and fixed, avoiding the deformation and damage of the filter core and increasing the filtering effect of the entire filtering equipment, but the filter bag annular mouth is made of hard plastics, causing it to be broken or deformed easily. In addition, the filter bag annular mouth only can be in tight contact with the metal filter drum because the both are made of hard materials when they are combined with each other closely, which always cannot achieve the accurate tight sealing, causing liquid to flow out through the contact position thereof, resulting in the incapability of complete tight fit.

### SUMMARY OF THE INVENTION

To overcome above shortcomings, the present invention proposes a filtering device, including a filter unit including a first annular body and a filter bag in combination with a bottom of the first annular body, the top face of the first annular body is folded outward to form an outer eaves portion, the outer side bottom of the outer eaves portion is configured with a second annular body, the filter unit is adapted to be in combination with a housing, the inner wall of the top of which is configured downward with an annular second stepped portion, the inside of the housing has an accommodation space in communication with the outside, the bottom of the housing is configured with an output port in communication with the accommodation space, the top face of the housing is adapted to be in combination with a cover used to seal the accommodation space, the top of the cover is configured with an input port, the diameter of the second annular body is larger than the one of the second stepped portion, allowing the second annular body to be pressed to engage with the second stepped portion and to expand to pressed against the second stepped portion, thereby increasing a liquid-tight effect and use of the filter unit.

### BRIEF DESCRIPTION OF THE DRAWINGS

FIG. 1 is a perspective view of the present invention;

FIG. 2 is an exploded view of the present invention;

FIG. 3 is a cross-sectional view of a first annular body and second annular body of the present invention; and

FIG. 4 is a cross-sectional view of a filter unit in combination with a housing of the present invention.

### DETAILED DESCRIPTION OF THE PREFERRED EMBODIMENTS

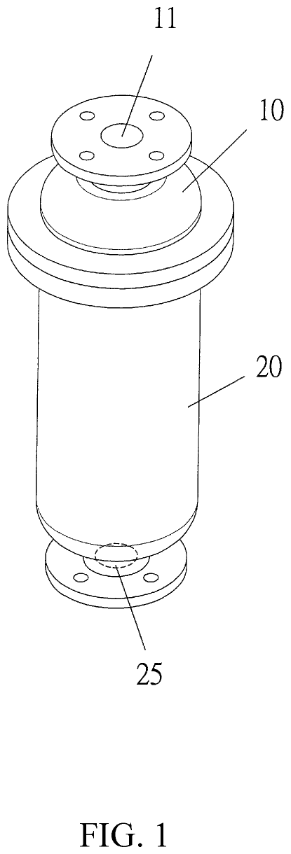

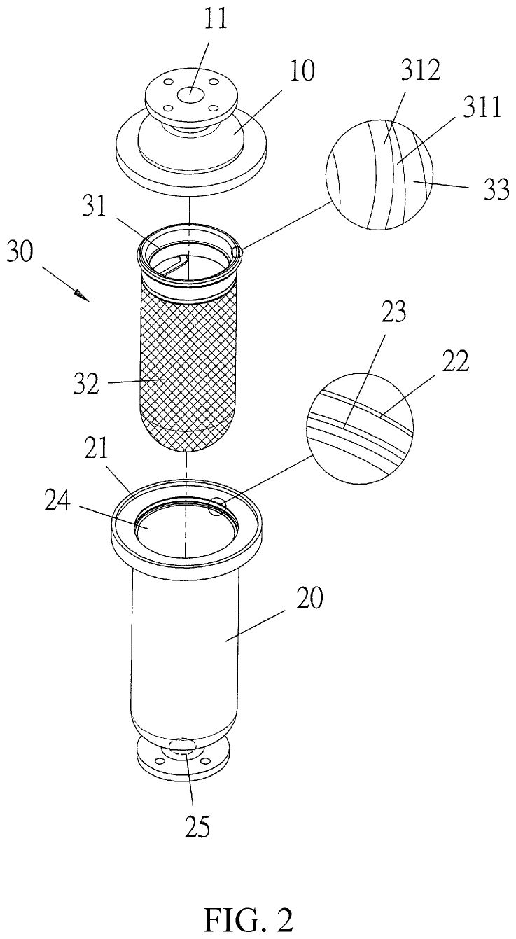

Referring to FIGS. 1 and 2, a filtering device of the present invention includes a cover 10, housing 20 and filter unit 30.

The cover 10 is configured with an input port 11 on the top thereof.

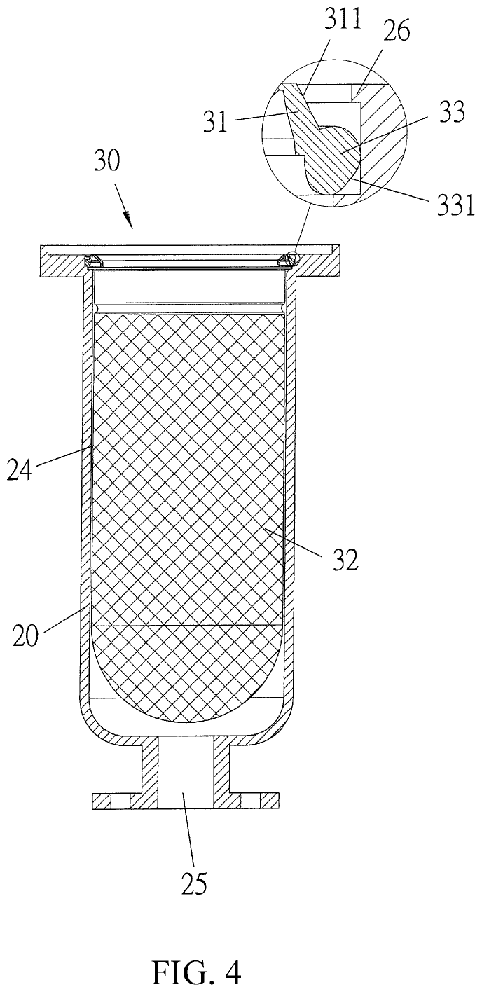

Referring to FIGS. 2 and 4, the housing 20 is in combination with the cover 10; the top face of the housing 20 is configured downward with an annular stepped portion 21; the inner wall of the top of the housing 20 is configured downward with an annular second stepped portion 22 and configured downward with an annular third stepped portion 23 in sequence; the inside of the housing 20 has an accommodation space 24 in communication with the outside; the bottom of the housing 20 is configured with an output port 25 in communication with the accommodation space 24; and the top face is inward extended with a stopper 26 positioned above the second stepped portion 22.

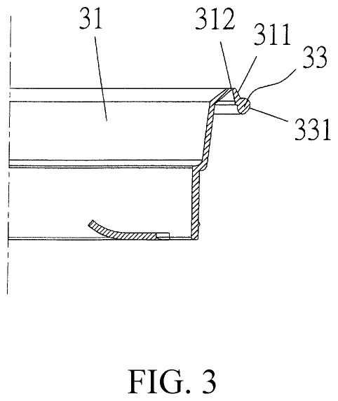

Referring to FIGS. 2 to 4, the filter unit 30 includes a first annular body 31 and a filter bag 32 in combination with the bottom of the first annular body 32, where the top face of the first annular body 31 is folded outward to form an outer eaves portion 311, the bottom of the outer side of which is configured with a second annular body 33, and the top face of the first annular body 31 is inclined outward and the outer side of the outer eaves portion 311 is inclined inward, with a plane part 312 being formed between the top face of the first annular body 311 and the top face of the outer eaves portion 311.

The width of the top face of the second annular body 33 is larger than the one of the bottom face thereof, allowing an oblique face portion 331 to be formed between the outer side of the top face of the second annular body 33 and the outer side of the bottom face thereof. The filter unit is installed in the accommodation space 24, allowing the second annular body 33 to be in engagement with the second stepped portion 22 and the filter bag 32 to be positioned in the accommodation space.

The diameter of the second annular body 33 is larger than the one of the second stepped portion 22, allowing the second annular body 33 to be tightly engaged with the second stepped portion 22 and to expand to press against the second stepped portion 22. Specifically, the first annular body is made of plastics or rubber, the second annular body thermoplastic vulcanizate, and the diameter of the second annular body 33 is slightly larger than the one of the second stepped portion 22 so that it is necessary to slightly squeeze the first annular body 31 and the second annular body 33, and they can then be placed into the second stepped portion 22 upon assembly. Thereafter, the second annular body 33 naturally, elastically expands outward to press against the second stepped portion 22 so as to have a good liquid-tight effect.

1. A filtering device, comprising:
a cover, a top thereof configured with an input port;
a housing, in combination with said cover, a top face of said housing configured downward with an annular first stepped portion, a top of an inner wall of said housing configured downward with an annular second stepped portion and annular third stepped portion in sequence, an inside of said housing having an accommodation space in communication with the outside, and a bottom of said housing configured with an output port in communication with said accommodation space; and
a filter unit, comprising a first annular body and a filter bag in communication with a bottom of said first annular body, a top face of said first annular body folded outward to form an outer eaves portion, a bottom of an outer side of said outer eaves portion configured with a second annular body, a width of a top face of said second annular body larger than a width of a bottom face thereof, allowing an oblique face to be formed between an outer side of said top face of said first annular body and an outer side of said bottom face of said second annular body, and said filter unit installed in said accommodation space, allowing said second annular body to be in engagement with said second stepped portion;
wherein a top face of said housing is extended inward with a stopper positioned above said second stepped portion, the stopper being extended from and fixed to said housing.

2. (canceled)

3. The device according to claim 1, wherein a diameter of said second annular body is larger than a diameter of said second stepped portion, allowing said second annular body to be in tight engagement with said second stepped portion and to expand to press against said second stepped portion.

4. The device according to claim 1, wherein a top face of said first annular body is inclined outward, an outer side of said outer eaves portion inclined inward, and a plane part is formed between said top face of said first annular body and a top face of said outer eaves portion.

5. The device according to claim 1, wherein said first annular body is made of plastics or rubber, and said second annular body thermoplastic vulcanizate.

6. A filtering device, comprising:
a filter unit comprising a first annular body and a filter bag in combination with a bottom of said first annular body, a top face of said first annular body folded outward to form an outer eaves portion, a bottom of an outer side of said outer eaves portion configured with an second annular body, a width of a top face of sand second annular body larger than a width of a bottom face thereof, allowing a first oblique face portion to be formed between an outer side of said top face of said second annular body and an outer side of said bottom face thereof;
wherein said filter unit is receivable in a housing and a top face of said housing is extended inward with a stopper, the stepper being extended from and fixed to said housing.

7. The device according to claim 6, wherein a top face of said housing is configured downward with an annular first stepped portion, an inner wall of a top of said housing is configured downward with an annular second stepped portion and annular third stepped portion in sequence, an inside of said housing has an accommodation space in communication with the outside, a bottom of said housing is configured with an output port in communication with said accommodation space, a top face of said housing is adapted to be in combination with a cover to seal said accommodation space, and a top of said cover is configured with an input port.

8. The device according to claim 7, wherein the stopper is positioned above said second stepped portion.

9. The device according to claim 6, wherein a top face of said first annular body is inclined outward, an outer side of said outer eaves portion inclined inward, and a plane part is formed between said top face of said first annular body and a top face of said outer eaves portion.

10. The device according to claim 6, wherein a diameter of said second annular body is larger than a diameter of said second stepped portion, allowing said second annular body to be in tight engagement with said second stepped portion and to expand to press against said second stepped portion.

11. The device according to claim 6, wherein said first annular body is made of plastics or rubber, and said second annular body thermoplastic vulcanizate.
